(19) United States
(12) Patent Application Publication
(10) Pub. No.: US 2017/0321622 A1
(43) Pub. Date: Nov. 9, 2017

(54) INTERNAL COMBUSTION ENGINE CYLINDER HEAD WITH MULTI-RUNNER, MULTI-PORT INTEGRATED EXHAUST MANIFOLD

(71) Applicant: GM GLOBAL TECHNOLOGY OPERATIONS LLC, Detroit, MI (US)

(72) Inventors: Alan W. Hayman, Romeo, MI (US); Rodney E. Baker, Fenton, MI (US)

(73) Assignee: GM GLOBAL TECHNOLOGY OPERATIONS LLC, Detroit, MI (US)

(21) Appl. No.: 15/147,292

(22) Filed: May 5, 2016

(51) Int. Cl. F02F 1/24; F02F 11/00

(52) U.S. Cl. CPC F02F 1/243; F02F 11/002

(57) ABSTRACT

Disclosed are integrated exhaust manifold (IEM) cylinder heads, methods for making and methods for using IEM cylinder heads, and motor vehicles with an engine and IEM cylinder head assembly. Disclosed, for example, is an IEM cylinder head for a motor vehicle with an engine and an exhaust system. The IEM cylinder head includes a body that mounts to the engine's cylinder block. The cylinder head body integrally defines: multiple chamber surfaces each aligning with a cylinder bore and piston to define a combustion chamber; multiple exhaust ports each communicating with a cylinder bore to evacuate exhaust gas therefrom; multiple exit ports communicating with the exhaust system to evacuate exhaust gas from the cylinder head; and multiple exhaust runners each extending from an exhaust port to one exit port. These exhaust runners are fluidly isolated from each other to each transmit exhaust gases from a single one of the cylinder bores.

### TECHNICAL FIELD

The present disclosure relates generally to powertrain systems for motor vehicles. More specifically, aspects of this disclosure relate to internal combustion engines with a cylinder head configuration having an integrated exhaust manifold.

### BACKGROUND

Conventional motor vehicles, such as the modern-day automobile, include a powertrain that operates to propel the vehicle and power the onboard vehicle electronics. The powertrain, which is inclusive of and sometimes improperly referred to as a drivetrain, is generally comprised of an engine that delivers driving power to the vehicle's final drive system (e.g., rear differential, axle, and wheels) through a multi-speed power transmission. Automobiles have traditionally been powered by a reciprocating-piston type internal combustion engine (ICE) because of its ready availability and relatively inexpensive cost, light weight, and overall efficiency. Such engines include two or four-stroke compression-ignited diesel engines and four-stroke spark-ignited gasoline engines. Hybrid vehicles, on the other hand, utilize alternative power sources, such as electric motor-generators, to propel the vehicle, minimizing reliance on the engine for power and increasing overall fuel economy.

A typical over-head valve internal combustion engine includes an engine block with cylinder bores each having a piston reciprocally movable therein. Coupled to a top surface of the engine block is a cylinder head that cooperates with the piston and cylinder bore to form a variable-volume combustion chamber. These reciprocating pistons are used to convert pressure, generated by igniting a fuel-and-air mixture in the combustion chamber, into rotational forces to drive a crankshaft. The cylinder head defines intake ports through which air, provided by an intake manifold, is selectively introduced to the combustion chamber. Also defined in the cylinder head are exhaust ports through which exhaust gases and byproducts of combustion are selectively evacuated from the combustion chamber to an exhaust manifold. The exhaust manifold, in turn, collects and combines the exhaust gases for recirculation into the intake manifold, delivery to a turbine-driven turbocharger, or evacuation from the ICE via an exhaust system.

A conventional cylinder head (or heads, if the engine has multiple banks of cylinders) is an aluminum or iron casting that is detachable from the engine block, and contains the ICE's spark plugs, inlet valves, exhaust valves, and, in some instances, a camshaft. Typically, the exhaust manifold is affixed to the side of the cylinder head, e.g., by bolts and a manifold gasket. The exhaust manifold communicates with the exhaust ports to deliver exhaust gases to an exhaust after treatment system and exhaust silencer for subsequent release to the atmosphere. The exhaust manifold, which is typically formed from stainless steel or cast iron, includes runners coupled with the cylinder head exhaust ports. An exhaust manifold collector volume is in downstream fluid communication with the runners to pool the exhaust gases prior to delivery to the components of the vehicle exhaust system. Recently, cylinder heads have been designed with the exhaust manifold, i.e., the exhaust runners and exhaust collector volume, internally defined by the cylinder head casting to integrally form an integrated exhaust manifold (IEM).

### SUMMARY

Disclosed herein are integrated exhaust manifold (IEM) cylinder heads for a motor vehicle engine, methods for making and methods for using IEM cylinder heads, and motor vehicles with an internal combustion engine (ICE) including one or more IEM cylinder heads. By way of example, and not limitation, an improved cylinder head for an ICE of a motor vehicle is disclosed. The cylinder head, which may be of a 6-cylinder V-type configuration (most commonly referred to as a “V6”), has an integrated exhaust manifold with multiple distinct exhaust runners designed to reduce “manifolding effect” within the cylinder head. As an example, the cylinder head is cast with an integrally formed individual runner for each of the cylinders (e.g., one runner per two cylinder exhaust ports). These runners are fluidly isolated and physically segregated from each other to exit the cylinder head without any fluid blending of the exhaust gases from the other cylinders. To accommodate this design, the cylinder head has a separate, fluidly isolated runner exit port for each runner at the flanged exit of the cylinder head manifold. These runner exit ports can optionally be lengthened further within the geometry of the turbo housing, e.g., for increased thermal dissipation and further reduction of manifolding effect (i.e., reduced internal blending of exhaust gas evacuated from multiple cylinders).

Attendant benefits for at least some of the disclosed concepts include optimization of fuel trim for each cylinder by means of sampling the individual exhaust runners in an integrated exhaust manifold instead of calculating an average of multiple runners. The fueling for each cylinder would feed back by virtue of individualized oxygen sensor determination of the oxygen content in the fuel exhaust for that specific cylinder. Individualized sampling within the dedicated exhaust port runner allows for a more accurate fuel trim calculation and air/fuel ratio adjustment for each cylinder. This, in turn, helps to enable improved fuel economy and increased power since all of the cylinders can be run, for example, at substantially identical air/fuel ratios. This design also accommodates an option to “offset” the runner exit ports for turbo or exhaust manifold, e.g., to improve component packaging within the engine compartment. The multi-port IEM cylinder head exit allows for improved cooling of the metallic material at the exhaust port runner flange. When compared to traditional cylinder head and exhaust manifold assemblies, an IEM cylinder head configuration as disclosed herein can also offer reduced emissions, reduced engine weight and width, and the elimination of traditional manifold assembly parts, such as the gasket, heat shield, and manifold fasteners.

Aspects of the present disclosure are directed to exhaust manifolds and cylinder heads for motor vehicle engines. Disclosed, for example, is an IEM cylinder head for a motor vehicle with an engine and an exhaust system. The engine includes an engine block with a multiple cylinder bores and a multiple pistons. Each piston is disposed in a respective one of the cylinder bores. The IEM cylinder head includes a cylinder head body that is configured to attach to the engine block. The cylinder head body integrally defines: a plurality of chamber surfaces, each of which is configured to align with a respective one of the cylinder bores and pistons to cooperatively define a combustion chamber; a plurality of exhaust ports, each of which is configured to communicate with a respective one of the cylinder bores and evacuate exhaust gas therefrom; a plurality of runner exit ports, each of which is configured to communicate with the exhaust system to evacuate exhaust gas from the cylinder head body; and a plurality of exhaust runners, each of which extends from an exhaust port to one of the runner exit ports. The exhaust runners are segregated and fluidly isolated from each other such that each runner transmits exhaust gases from a single cylinder bore to the exhaust system through a single runner exit port.

Other aspects of the present disclosure are directed to motor vehicles with one or more integrated exhaust manifolds. A “motor vehicle,” as used herein, may include any relevant vehicle platform, such as passenger vehicles (internal combustion engine (ICE), hybrid, etc.), industrial vehicles, buses, all-terrain vehicles (ATV), motorcycles, farm equipment, boats, airplanes, etc. In one example, a motor vehicle is disclosed that includes a vehicle body with an engine compartment. An exhaust system with an exhaust discharge pipe is attached to the vehicle body. Disposed within the vehicle's engine compartment is an internal combustion engine (ICE) assembly. The ICE assembly includes an engine block having a cylinder bank with a series of cylinder bores. A piston is reciprocally movable within each one of these cylinder bores. In a V-type engine configuration, the ICE assembly would include multiple cylinder banks.

The ICE assembly also includes an integrated exhaust manifold (IEM) cylinder head with a single-piece unitary cylinder head body that is attached to the engine block on top of the cylinder bank. In a V-type engine configuration, the ICE assembly may include multiple IEM cylinder heads, e.g., one for each cylinder bank. The cylinder head body integrally defines: a series of chamber surfaces, each of which is aligned with a respective cylinder bore and piston to cooperatively define a combustion chamber; a series of exhaust ports, each of which is fluidly coupled to one of the cylinder bores to evacuate exhaust gas therefrom; a flange region that projects from an outer surface of the cylinder head body and includes a series of runner exit ports fluidly coupled to the exhaust discharge pipe to evacuate exhaust gas from the cylinder head body; and a series of exhaust runners, each of which extends from an exhaust port to one of the runner exit ports. The runner exit ports are segregated and fluidly isolated from each other such that each exit port evacuates to the exhaust system the exhaust gases from a single one of the exhaust runners. Likewise, the exhaust runners are segregated and fluidly isolated from each other such that each runner evacuates through a single one of the runner exit ports exhaust gases from a single one of the cylinder bores.

According to other aspects of the present disclosure, methods of making and methods of using engine cylinder heads are presented. For instance, a method of constructing an IEM cylinder head for a motor vehicle is disclosed. The motor vehicle includes an engine and an exhaust system. The engine includes an engine block with multiple cylinder bores and a piston disposed in each one of the cylinder bores. The method includes: forming a cylinder head body that is configured to attach to the engine block; forming on the cylinder head body a plurality of chamber surfaces, each of which is configured to align with a respective one of the cylinder bores and pistons to cooperatively define a combustion chamber; forming on the cylinder head body a plurality of exhaust ports, each of which is configured to communicate with a respective one of the cylinder bores and evacuate exhaust gas therefrom; forming on the cylinder head body a plurality of runner exit ports, each of which is configured to communicate with the exhaust system to evacuate exhaust gas from the cylinder head body; and forming in the cylinder head body a plurality of exhaust runners, each of which extends from a respective one of the exhaust ports to a respective one of the runner exit ports. The exhaust runners are segregated and fluidly isolated from each other to each transmit exhaust gases from a single one of the cylinder bores, through a single one of the runner exit ports, to the exhaust system. In at least some embodiments, the forming steps of the method include casting the cylinder head body—including the chamber surfaces, the exhaust ports, the runner exit ports, and the exhaust runners—from a metallic material (e.g., cast aluminum, stainless steel or cast iron) as a single-piece, unitary structure.

The above summary is not intended to represent every embodiment or every aspect of the present disclosure. Rather, the foregoing summary merely provides an exemplification of some of the novel aspects and features set forth herein. The above features and advantages, and other features and advantages of the present disclosure, will be readily apparent from the following detailed description of representative embodiments and modes for carrying out the present disclosure when taken in connection with the accompanying drawings and the appended claims.

### BRIEF DESCRIPTION OF THE DRAWINGS

FIG. 1 is a schematic rear-view illustration of a representative 6-cylinder V-type internal combustion engine having cylinder heads with integrated exhaust manifolds in accordance with aspects of the present disclosure.

FIG. 2 is a schematic top-view illustration of the representative internal combustion engine of FIG. 1.

FIG. 3 is a partially schematic perspective-view illustration of a representative engine assembly with an integrated exhaust manifold (IEM) cylinder head mounted to a cylinder block (shown in phantom) in accordance with aspects of the present disclosure.

FIG. 4 is a bottom perspective-view illustration of three of the isolated and fluidly segregated exhaust runners of the IEM cylinder head of FIG. 3.

FIG. 5 is a side perspective-view illustration of the three representative exhaust runners of FIG. 4.

FIG. 6 is a front perspective-view illustration of the three representative exhaust runners of FIG. 4.

The present disclosure is susceptible to various modifications and alternative forms, and some representative embodiments have been shown by way of example in the drawings and will be described in detail herein. It should be understood, however, that the novel aspects of this disclosure are not limited to the particular forms disclosed. Rather, the disclosure is to cover all modifications, equivalents, combinations, subcombinations, and alternatives falling within the spirit and scope of the disclosure as defined by the appended claims.

### DETAILED DESCRIPTION OF THE ILLUSTRATED EMBODIMENTS

This disclosure is susceptible of embodiment in many different forms. There are shown in the drawings and will herein be described in detail representative embodiments of the disclosure with the understanding that the present disclosure is to be considered as an exemplification of the principles of the disclosure and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference or otherwise. For purposes of the present detailed description, unless specifically disclaimed: the singular includes the plural and vice versa; the words “and” and “or” shall be both conjunctive and disjunctive; the word “all” means “any and all”; the word “any” means “any and all”; and the words “including” and “comprising” and “having” mean “including without limitation.” Moreover, words of approximation, such as “about,” “almost,” “substantially,” “approximately,” and the like, can be used herein in the sense of “at, near, or nearly at,” or “within 3-5% of,” or “within acceptable manufacturing tolerances,” or any logical combination thereof, for example.

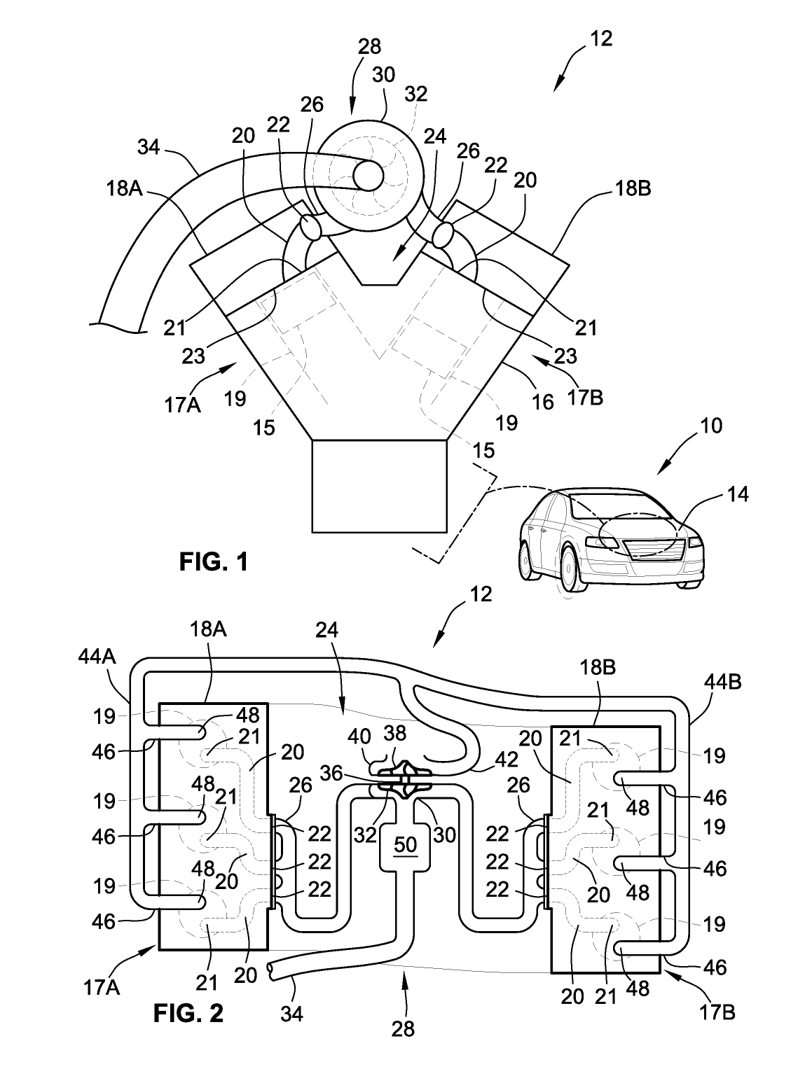

Referring now to the drawings, wherein like reference numbers refer to like features throughout the several views, there is shown in FIG. 1 a perspective-view illustration of a representative automobile, designated generally at 10, with a powertrain system, which is represented in part by an internal combustion engine (ICE) assembly 12. Mounted at a forward portion of the automobile 10, e.g., aft of a front bumper fascia and grille and forward of a passenger compartment, the ICE assembly 12 is mounted within an engine compartment that is covered by an engine hood 14. The illustrated automobile 10—also referred to herein as “motor vehicle” or “vehicle” for short—is merely an exemplary application with which the novel aspects of this disclosure can be practiced. In the same vein, the implementation of the present concepts into a 6-cylinder V-type engine configuration should also be appreciated as an exemplary application of the novel concepts disclosed herein. As such, it will be understood that the aspects and features of the present disclosure can be integrated into other engine assemblies and utilized for any type of motor vehicle. Lastly, the drawings presented herein, are not necessarily to scale and are provided purely for instructional purposes. Thus, the specific and relative dimensions shown in the drawings are not to be construed as limiting.

There is shown in FIG. 1 a representative V-type 6-cylinder (V6) reciprocating-piston ICE assembly 12. The ICE assembly 12 operates to propel the vehicle 10, for example, as a compression-ignited (CI) diesel engine or spark-ignited (SI) gasoline engine, including flexible-fuel vehicle (FFV) and hybrid vehicle variations thereof. The ICE assembly 12 has an engine block 16 (often used synonymously with “cylinder case”) with first and second banks 17A and 17B, respectively, of cylinder bores 19. As shown, the banks of cylinder bores (or “cylinder banks” for short) 17A, 17B are disposed at an included angle of less than 180 degrees relative to each other. Each cylinder bank 17A, 17B defines therein one or a plurality of cylinder bores, shown in phantom at 19 in FIGS. 1 and 2. A piston 15 is reciprocally movable within each of the cylinder bores 19. Only select components of the ICE assembly 14 have been shown by way of example in the drawings and will be described in detail herein. However, it should be understood that the ICE assembly 14 can include other known and hereafter developed engine features within the scope of this disclosure.

First and second integrated exhaust manifold (IEM) cylinder heads 18A and 18B are respectively mounted to the first and second cylinder banks 17A, 17B, e.g., via threaded fasteners (not shown). Chamber surfaces 23, integrally formed along the bottom of each IEM cylinder head 18A, 18B, are positioned to each align with one of the cylinder bores 19, as well as the piston 15 disposed therein, to cooperatively define a variable-volume combustion chamber. This pair of IEM cylinder heads 18A, 18B defines a corresponding number of exhaust ports 21 (e.g., one or two ports per combustion chamber) through which exhaust gases and byproducts of combustion are selectively evacuated from the cylinder bores 19. Each exhaust port 21 communicates exhaust gases—such as through a dedicated exhaust runner 20—to a respective runner exit port 22, all of which are defined within the cylinder head 18A, 18B. The runner 20 and exit port 22 features of the IEM are formed integrally with the respective cylinder heads 18A, 18B, thereby obviating the need for fasteners and gaskets typically required for exhaust manifold attachment. In so doing, the exhaust runners 20 are extensions of the exhaust ports 21 for connecting each exhaust port 21 to an exit port 22 in the cylinder head 18A, 18B to evacuate exhaust gas from the engine 12. A respective discharge pipe 26 is in fluid communication with each integral exhaust manifold, namely the runner exit port 22. Potential exhaust gas leak paths during operation of the ICE assembly 12 are reduced by integrally forming the IEM features are with the cylinder heads 18A, 18B.

In the example illustrated in FIGS. 1 and 2, a turbine-driven forced-induction turbocharger 28 is fluidly coupled to the ICE assembly 12, e.g., disposed within a valley 24 defined between the cylinder banks 17A, 17B. Turbocharger 28 includes a turbine housing 30 into which the discharge pipes 26 communicate exhaust gases from the IEM cylinder heads 18A, 18B. Optional engine configurations can eliminate the discharge pipes 26 by incorporating exhaust discharge conduits into the turbine housing 30. Heat and kinetic energy of the exhaust gases cause a turbine blade, shown in phantom at 32 in FIG. 1, to spin or rotate within the turbine housing 30. When some or all of the useful energy is removed by the turbocharger 28, the exhaust gases are communicated to a turbine discharge pipe 34 for eventual release to the atmosphere. The inboard configuration of the IEM cylinder heads 18A, 18B permit the length of the discharge pipes 26 to be minimized. By minimizing the length of the discharge pipes 26, more heat energy of the exhaust gas—that would otherwise be lost to the atmosphere through heat transfer—may be retained to rotate the turbine blade 32. While the ICE assembly 12 shown in FIGS. 1 and 2 includes the turbocharger 28, those skilled in the art will recognize that the turbocharger 28 may be eliminated or modified while remaining within the scope of this disclosure.

Referring to FIG. 2, there is shown a top schematic view of the ICE assembly 12 and turbocharger assembly 28 presented in FIG. 1. As shown, the turbine blade 32 is securely connected, e.g., through a turbine shaft 36, to a compressor blade 38 for common rotation therewith. The rotating compressor blade 38 cooperates with a compressor housing 40 to induct air at generally atmospheric pressure and subsequently compress the air. The compressed air is communicated to a compressor outlet duct 42, which is fluidly coupled with first and second intake manifolds 44A and 44B, respectively. Both intake manifolds 44A, 44B operate to distribute the air to an arrangement of intake runners 46 that are each in fluid communication with a respective one of various intake ports 48. Similar to the exhaust ports 21, these intake ports 48 are formed integrally by each of the first and second cylinder heads 18A, 18B. The intake ports 48 selectively introduce air, e.g., through operation of one or more poppet valves, to a respective one of the cylinder bores 16 where the air, along with a fuel charge, is subsequently combusted. Intake ports 48 may be provided on either the inboard side or the outboard side of the cylinder heads 18A, 18B. An optional exhaust aftertreatment device 50, such as an exhaust gas catalyst or a particulate trap, can be disposed in downstream flow relation to the turbocharger 28.

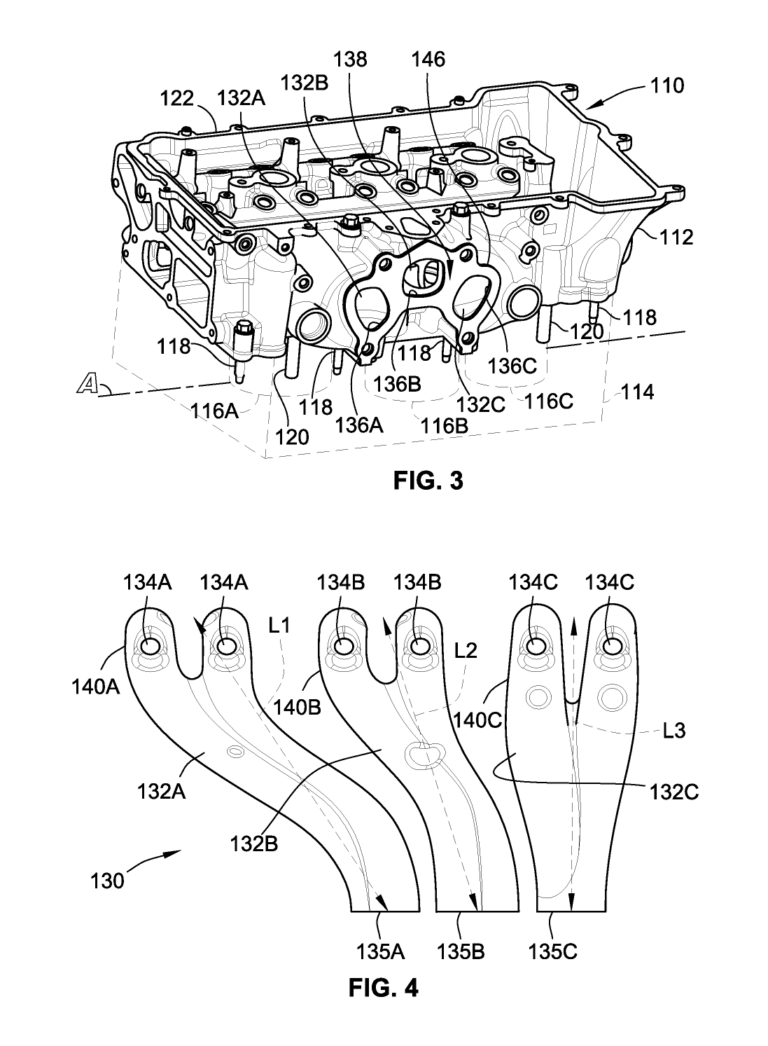

FIG. 3 shows a more detailed view of a portion of a representative internal combustion engine assembly, designated generally at 100, that includes an IEM cylinder head 112 mounted onto a bank of an engine cylinder block, which is shown in phantom at 114. The illustrated bank of the cylinder block 114 has three cylinders—a first cylinder 116A, a second cylinder 116B, and a third cylinder 116C—arranged in series along an axis A. The IEM cylinder head 112 mounts to the cylinder block 114 with various bolts and lug fasteners 118 and 120, respectively. Intake valves and exhaust valves (not visible in the view provided) are mounted to a lower cylinder-head-facing side of the IEM cylinder head 112. These valves are electronically controlled by an engine controller (not shown) to control air flow through the intake valves into the cylinders 116A-116C, and exhaust flow out of the cylinders 116A-116C through the exhaust valves to meet a predetermined valve timing and engine firing schedule. The engine controller can also control fuel trim and ignition within the cylinders.

The cylinder head 112 has an integrated exhaust manifold 130 (FIGS. 4-6) that provides three unique exhaust flow paths through three separate and distinct exhaust runners 132A, 132B and 132C. The IEM 130 configuration separates exhaust gas pulses from each cylinder 116A-116C, for example, to reduce or otherwise eliminate “manifolding effect” and help improve thermal energy dissipation to and through the cylinder head body 122. By way of non-limiting example, the first exhaust flow path by way of first runner 132A has first inlet point(s) 134A (FIG. 4) at the exhaust valve(s)/port(s) of the first cylinder 116A, and extends to a single first exit point 135A at a first runner exit port 136A opened at a flanged side face 138 of the cylinder head body 122. Likewise, the second exhaust flow path by way of second runner 132B has second inlet point(s) 134B at the exhaust valve(s)/port(s) of the second cylinder 116B, and extends to a single second exit point 135B at a second runner exit port 136B opened at the cylinder head's flanged side face 138. Lastly, the third exhaust flow path by way of third runner 132C has third inlet point(s) 134C at the exhaust valve(s)/port(s) of the third cylinder 116C, and extends to a single third exit point 135C at a third runner exit port 136B on the flanged side face 138.

In the illustrated example, the runner exit ports 136A-136C are the only exhaust outlets of the integrated exhaust manifold 130. Thus, each of the cylinders 116A-116C has a separate, dedicated exhaust runner 132A-132C, respectively, and thus a physically segregated, fluidly isolated unique flow path through the integrated exhaust manifold 130. At no point do any of the runners merge, for example, at an internal exhaust manifold collector volume to form a common flow passage before exiting the IEM cylinder head 112. This design allows for individual cylinder trim while accommodating an option to offset the runner exit ports, which helps to improve fuel economy, engine power, and engine packaging. It should be recognized that the number of inlet point(s) 134A-134C per runner 132A-132C will typically depend on the number of exhaust ports in each cylinder 116A-116C. Likewise, the number of runners and commensurate number of exits can be modified, for example, to accommodate engines with a different cylinder count.

Similar to the IEM cylinder heads 18A, 18B illustrated in FIGS. 1 and 2, the IEM cylinder head 112 of FIG. 3 comprises a single-piece, unitary cylinder head body 122, e.g., cast from aluminum, iron or steel, for housing the ICE assembly's 110 spark plugs, inlet valves, exhaust valves, etc. This unitary cylinder head body 122 integrally defines on a lower surface thereof a series of chamber surfaces (e.g., chamber surfaces 23 of FIG. 1), each of which aligns with one cylinder bore, including the piston disposed therein, to cooperatively define a variable-volume combustion chamber. Formed integrally within the body 122 is a series of exhaust ports (e.g., exhaust ports 21 of FIG. 1), each of which communicates with one of the cylinder bores 116A-116C to evacuate exhaust gas therefrom. The arrangement of runner exit ports 136A-136C are also integrally formed in the unitary cylinder head body 122, fluidly coupled with the vehicle's exhaust system (e.g., discharge pipe 34 and exhaust aftertreatment device 50 of FIG. 2) to evacuate exhaust gas from the IEM cylinder head 112. Likewise, each integrally formed exhaust runner 132A-132C extends from a single cylinder 116A-116C (e.g., from a respective one or ones of the exhaust ports for a cylinder bore) to a single runner exit port 136A-136C. The exhaust runners 132A-132C are formed as physically segregated and fluidly isolated structures such that each runner transmits exhaust gas from a single cylinder bore.

As seen in FIG. 4, the exhaust runners 132A-132C provide each cylinder with a unique exhaust inlet, exhaust outlet, and exhaust flow path. In particular, the first flow path of the first exhaust runner 132A can be delineated by a first plan-view cross-section 140A that may be defined by drawing the planform perimeter of the runner 132A in the position of a horizontal plane passing transversely from left-to-right in FIG. 4 through the center of runner 132A. Likewise, second and third flow paths of the second and third exhaust runner 132A, 132B, respectively, can be delineated by respective second and third plan-view cross-sections 140B, 140C that are defined in a similar manner. As shown, the three plan-view cross-sections 140A140C and, thus, the three flow paths are distinct from each other. Also shown in FIG. 4 are the unique entry and exit points 134A and 135A, respectively, of the first exhaust runner 132A, which are distinct from the entry and exit points 134B and 135B, respectively, of the second exhaust runner 132B, both of which are distinct from the entry and exit points 134C and 135C, respectively, of the third exhaust runner 132C.

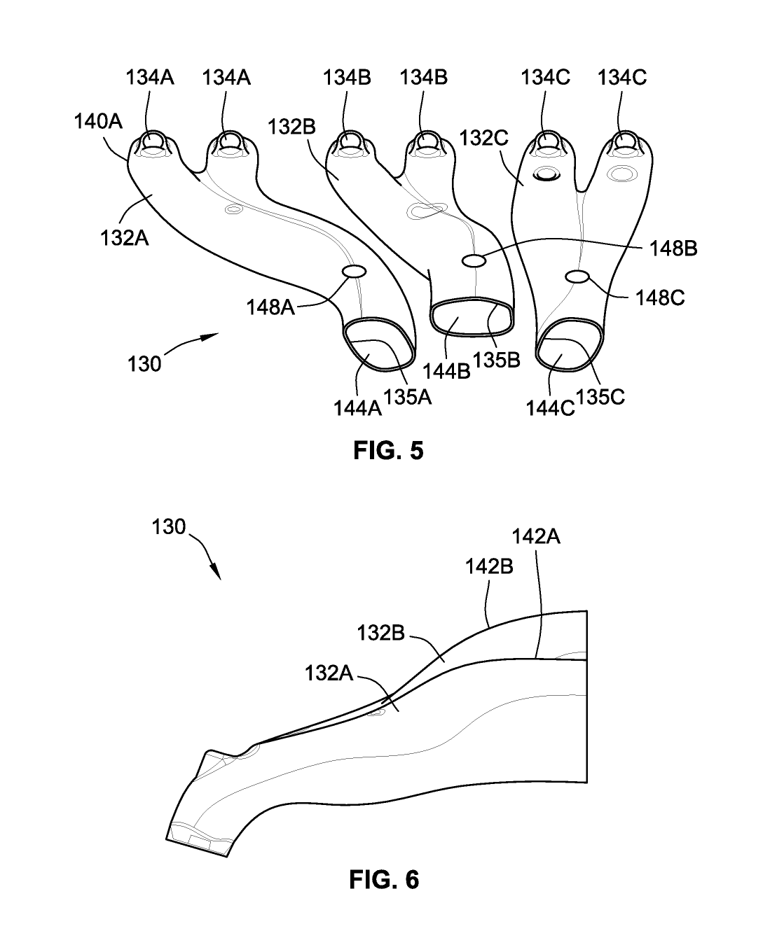

FIG. 6 is a supplemental view to help show that the exhaust runners 132A-132C are provided with unique geometries and surface areas. For instance, the first exhaust runner 132A has a first side-view cross-section 142A that can be defined, for example, by drawing the perimeter of the runner 132A in the position of a vertical plane passing transversely from left-to-right in FIG. 6 through the center of runner 132A. Likewise, the second and third exhaust runners 132B, 132B have respective second and third side-view cross-sections (the second designated at 142B; the side-view of third exhaust runner 132C not visible in FIG. 6) that can each be defined in the foregoing manner. The side-view cross-sections of the three runners 132A-132B are distinct from each other. Moreover, the first, second and third runners 132A-132B also have distinct first, second and third lengths L1, L2 and L3, respectively, as seen in FIG. 4. With the different exhaust runner geometries (e.g., plan-view and side-view cross sections) and lengths, the first, second and third exhaust runners 132A-132B have distinct first, second and third internal surface areas, designated at 144A, 144B and 144C, respectively, in FIG. 5.

Turning back to FIG. 3, there is shown the first, second and third runner exit ports 136A, 136B and 136C, respectively, with respective first, second and third distinct positions and orientations along the flanged side face 138 that protrudes from the cylinder head body 122. As shown, the runner exit ports 136A-136C are positioned such that first and third exit ports 136A, 136C are vertically offset/spaced from the second exit port 136B, while all three exit ports 136A-136C are laterally offset/spaced from each other. In this regard, the first runner exit port 136A is shown with a first orientation that is different from a second orientation of the second runner exit port 136B, both of which are distinct from a third orientation of the third runner exit port 136C. A runner exit port gasket 146 can function to segregate and fluidly isolate the exit ports 136A-136C from each to ensure that each port evacuates to the exhaust system exhaust gas from a single one of the cylinder bores. First, second and third exhaust sensors 148A, 148B and 148C, respectively, are each attached to the cylinder head body 122 and fluidly coupled to a single one of the exhaust runners 132A-132C. The sensors 148A-148C sample exhaust flow from a single runner 132A-132C such that a unique fuel trim analysis can be provided for each individual cylinder 116A-116C.

While aspects of the present disclosure have been described in detail with reference to the illustrated embodiments, those skilled in the art will recognize that many changes may be made thereto without departing from the scope of the present disclosure. The present disclosure is not limited to the precise construction and compositions disclosed herein; any and all modifications, changes, and variations apparent from the foregoing descriptions are within the spirit and scope of the disclosure as defined in the appended claims. Moreover, the present concepts expressly include any and all combinations and subcombinations of the preceding elements and features.

What is claimed:

1. An integrated exhaust manifold (IEM) cylinder head for a motor vehicle with an engine and an exhaust system, the engine including an engine block with a plurality of cylinder bores and a plurality of pistons each disposed in a respective one of the cylinder bores, the IEM cylinder head comprising:
a cylinder head body configured to attach to the engine block, the cylinder head body integrally defining:
a plurality of chamber surfaces each configured to align with a respective one of the cylinder bores and pistons to cooperatively define a combustion chamber;
a plurality of exhaust ports each configured to communicate with a respective one of the cylinder bores and evacuate exhaust gas therefrom;
a plurality of runner exit ports each configured to communicate with the exhaust system to evacuate exhaust gas from the cylinder head body; and
a plurality of exhaust runners each extending from a respective one of the exhaust ports to a respective one of the runner exit ports, the exhaust runners being segregated and fluidly isolated from each other to each transmit exhaust gases from a single one of the cylinder bores.

2. The IEM cylinder head of claim 1, wherein the plurality of exhaust runners includes a first exhaust runner with a first plan-view cross-section and a second exhaust runner with a second plan-view cross-section distinct from the first plan-view cross-section.

3. The IEM cylinder head of claim 1, wherein the plurality of exhaust runners includes a first exhaust runner with a first side-view cross-section and a second exhaust runner with a second side-view cross-section distinct from the first side-view cross-section.

4. The IEM cylinder head of claim 1, wherein the plurality of exhaust runners includes a first exhaust runner with first entry and exit points and a second exhaust runner with second entry and exit points distinct from the first entry and exit points.

5. The IEM cylinder head of claim 1, wherein the plurality of exhaust runners includes a first exhaust runner with a first internal surface area and a second exhaust runner with a second internal surface area distinct from the first internal surface area.

6. The IEM cylinder head of claim 1, wherein the plurality of runner exit ports includes a first runner exit port with a first position and a second runner exit port with a second position distinct from the first position.

7. The IEM cylinder head of claim 1, wherein the plurality of runner exit ports includes a first runner exit port with a first orientation and a second runner exit port with a second orientation distinct from the first orientation.

8. The IEM cylinder head of claim 1, wherein the cylinder head body is characterized by a lack of an exhaust manifold collector volume fluidly connecting the exhaust runners within the runner exit ports.

9. The IEM cylinder head of claim 1, further comprising a plurality of exhaust sensors attached to the cylinder head body and each being fluidly coupled to a respective one of the exhaust runners.

10. The IEM cylinder head of claim 1, further comprising a gasket attached to the to the cylinder head body adjacent the runner exit ports, the gasket defining a plurality gasket apertures each aligned with a respective one of the runner exit ports.

11. The IEM cylinder head of claim 1, wherein the cylinder head body, including the plurality of chamber surfaces, the plurality of exhaust ports, the plurality of runner exit ports, and the plurality of exhaust runners, is cast from a metallic material as a single-piece, unitary structure.

12. The IEM cylinder head of claim 1, wherein the plurality of runner exit ports consists of three segregated and fluidly isolated runner exit ports, and the plurality of exhaust runners consists of three segregated and fluidly isolated exhaust runners.

13. A motor vehicle, comprising:
a vehicle body with an engine compartment;
an exhaust system with an exhaust discharge pipe attached to the vehicle body; and
an internal combustion engine (ICE) assembly disposed within the engine compartment, the ICE assembly comprising:
an engine block with a cylinder bank defining a plurality of cylinder bores;
a plurality of pistons each reciprocally movable within a respective one of the cylinder bores; and
an integrated exhaust manifold (IEM) cylinder head with a single-piece unitary cylinder head body attached to the engine block on top of the cylinder bank, the cylinder head body integrally defining:
a plurality of chamber surfaces each aligned with a respective one of the cylinder bores and pistons to cooperatively define a combustion chamber;
a plurality of exhaust ports each fluidly coupled to a respective one of the cylinder bores and configured to evacuate exhaust gas therefrom;
a flange region projecting from an outer surface of the cylinder head body, the flange region including a plurality of runner exit ports fluidly coupled to the exhaust discharge pipe and configured to evacuate exhaust gas from the cylinder head body, the runner exit ports being segregated and fluidly isolated from each other to each evacuate to the exhaust system exhaust gas from a single one of the cylinder bores; and
a plurality of exhaust runners each extending from a respective one of the exhaust ports to a respective one of the runner exit ports, the exhaust runners being segregated and fluidly isolated from each other to each evacuate through a single one of the runner exit ports exhaust gas from a single one of the cylinder bores.

14. A method of constructing an integrated exhaust manifold (IEM) cylinder head for a motor vehicle with an engine and an exhaust system, the engine including an engine block with a plurality of cylinder bores and a plurality of pistons each disposed in a respective one of the cylinder bores, the method comprising:
forming a cylinder head body configured to attach to the engine block;
forming on the cylinder head body a plurality of chamber surfaces each configured to align with a respective one of the cylinder bores and pistons to cooperatively define a combustion chamber;
forming on the cylinder head body a plurality of exhaust ports each configured to communicate with a respective one of the cylinder bores and evacuate exhaust gas therefrom;
forming on the cylinder head body a plurality of runner exit ports each configured to communicate with the exhaust system to evacuate exhaust gas from the cylinder head body; and
forming in the cylinder head body a plurality of exhaust runners each extending from a respective one of the exhaust ports to a respective one of the runner exit ports,
wherein the exhaust runners are segregated and fluidly isolated from each other to each transmit exhaust gases from a single one of the cylinder bores.

15. The method of claim 14, wherein the plurality of exhaust runners includes a first exhaust runner formed with a first plan-view cross-section and a second exhaust runner formed with a second plan-view cross-section distinct from the first plan-view cross-section.

16. The method of claim 14, wherein the plurality of exhaust runners includes a first exhaust runner formed with a first internal surface area and a second exhaust runner formed with a second internal surface area distinct from the first internal surface area.

17. The method of claim 14, wherein the plurality of runner exit ports includes a first runner exit port formed at a first position with a first orientation and a second runner exit port formed at a second position with a second orientation distinct from the first position and orientation.

18. The method of claim 14, wherein the cylinder head body is formed without an exhaust manifold collector volume fluidly connecting the exhaust runners within the runner exit ports.

19. The method of claim 14, further comprising attaching a plurality of exhaust sensors to the cylinder head body such that each of the exhaust sensors is fluidly coupled to a respective one of the exhaust runners.

20. The method of claim 14, wherein the forming steps comprise casting the cylinder head body, including the chamber surfaces, the exhaust ports, the runner exit ports, and the exhaust runners, from a metallic material as a single-piece, unitary structure.
